(19) United States
(12) Patent Application Publication
(10) Pub. No.: US 2003/0154268 A1
(43) Pub. Date: Aug. 14, 2003

(54) Management apparatus and computer program therefor

(75) Inventor: Takayuki Sato, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/063,934

(22) Filed: May 28, 2002

(30) Foreign Application Priority Data
Feb. 12, 2002 (JP) 2002-34687

(51) Int. Cl. G06F 15/173

(52) U.S. Cl. 709/223

(57) ABSTRACT

A management apparatus for managing a communication device having an identifying table storing unit for storing an identifying table with an identifying condition for determining a type of the communication device. The identifying condition corresponds to a check method for determining a function of the communication device that satisfies the identifying condition. An identifying unit determines whether or not the communication device satisfies the identifying condition and a check unit determines the function of the communication device by using the check method corresponding to the identifying condition, in a case where the communication device satisfies the identifying condition.

### CROSS REFERENCE TO RELATED APPLICATIONS

This patent application claims priority from a Japanese patent application No. 2002-034687 filed on Feb. 12, 2002, the contents of which are incorporated herein by reference.

### BACKGROUND OF INVENTION

1. Field of the Invention

The present invention relates to a management apparatus and a program therefor stored in a computer-readable medium. More particularly, the present invention relates to user-friendly management of a network system by performing various operations, such as identifying types of communication devices, and checking the functions and monitoring the status of the communication devices in the network system.

2. Description of the Related Art

Conventional methods for managing a communication device in a network system by using a management apparatus are disclosed, for example, in Unexamined Japanese Patent Applications Laid-Open Nos. 2001-308873, 6-315029 and 2001-217832.

Unexamined Japanese Patent Application Laid-Open No. 2001-308873 discloses a method and a system for displaying a diagram showing a general network configuration.

Unexamined Japanese Patent Application Laid-Open No. 6-315029 discloses an apparatus for checking attribute information of a communication device.

Unexamined Japanese Patent Application Laid-Open No. 2001-217832 discloses a method and a system for automatically detecting an arrangement of devices in a network system implementing SNMP (Simple Network Management Protocol).

The management apparatus of a network system performs management operations including identification of communication devices in the network system, check of functions of the communication devices, and the like. According to the conventional methods, however, such a management apparatus typically performed the above management operations by using separate, exclusive programs for the identification and the check of a function for a specific communication device.

In order to make management of a network system more convenient (i.e., user friendly), it is desirable to provide management functionality that is configured so that the configuration of the system can easily be determined and that is capable of being easily customized to suit the needs of a user.

### SUMMARY OF INVENTION

Therefore, it is an object of the present invention to provide a management apparatus and a computer program therefor, which are capable of overcoming the above drawbacks accompanying the conventional art. The above and other objects can be achieved by combinations described in the independent claims. The dependent claims define further advantageous and exemplary combinations of the present invention.

According to a first aspect of the present invention, a management apparatus for managing a communication device includes an identifying table storing unit operable to store an identifying table having an identifying condition for determining a type of the communication device. The identifying condition corresponds to a check method for determining a function of the communication device that satisfies the identifying condition. An identifying unit is operable to determine whether or not the communication device satisfies the identifying condition and a check unit is operable to determine the function of the communication device by using the check method that corresponds to the identifying condition, in a case where the communication device satisfies the identifying condition.

The management apparatus includes a check table storing unit operable to store a check table for each type of communication device. The check table having a check condition for determining the function of the communication device based upon a specified function corresponding to the check condition. The check table being specified by the check method stored in the identifying table storing unit. In a case where the communication device satisfies the identifying condition, and satisfies the check condition specified by the check method that corresponds to the satisfied identifying condition, the check unit determines that the communication device has the specified function corresponding to the check condition.

The management apparatus includes a default check table storing unit operable to store a default check table having a first check condition for determining the function of the communication device based upon a first specified function corresponding to the check condition; and a check table storing unit operable to store a check table for each type of communication device. The check table being specified by the check method stored in the identifying table storing unit, and having a second check condition for determining the function of the communication device based upon a second specified function corresponding to the second check condition. The check unit determines that, in a case where the communication device satisfies the first check condition of the default check table, the communication device has the first specified function corresponding to the first check condition, and determines that, in a case where the communication device satisfies the identifying condition stored in the identifying table, and satisfies the second check condition specified by the check method that corresponds to the satisfied identifying condition, the communication device has the second specified function corresponding to the second check condition.

The identifying table storing unit stores a monitoring method for monitoring a status of the communication device satisfying the identifying condition. The monitoring method corresponds to the identifying condition. The management apparatus includes a monitoring unit operable to monitor the status of the communication device by using the monitoring method corresponding to the identifying condition, in a case where the communication device satisfies the identifying condition.

The management apparatus includes a specifying unit operable to make a user of the management apparatus specify an address of the communication device and to make the identifying unit and the check unit determine the type and the function of the specified communication device, respectively.

The management apparatus includes a communication device displaying controller operable to show the communication device on a display of the management apparatus with an image corresponding to the type determined by the identifying unit; and a function displaying controller operable to show the function of the communication device determined by the check unit, in a case where a user of the management apparatus makes a predetermined operation with respect to the image.

The identifying table has a plurality of sets including respective combinations of identifying conditions for determining the type of the communication device and check methods for determining the function of the communication device based upon satisfying a corresponding identifying condition. The identifying unit determines which one of the identifying conditions is satisfied by the communication device based on predetermined priorities of each of the plurality of sets.

The management apparatus includes an input unit operable for a user of the management apparatus to input the plurality of sets to be registered in the identifying table; a registration unit operable to register the plurality of sets, input via the input unit, in the identifying table; and a priority setting unit operable to set the priorities for each of the plurality of sets registered in the identifying table based on the respective identifying conditions of the plurality of sets.

In a case where a first identifying condition of the identifying conditions is included in a second identifying condition of the identifying conditions, the priority setting unit sets the priorities such that a set corresponding to the first identifying condition has a higher priority than a priority of a set corresponding to the second identifying condition.

The management apparatus manages a plurality of communication devices, and the priority setting unit sets the priorities such that a set corresponding to one of the identifying conditions has a higher priority as a number of the plurality of communication devices satisfying the one identifying condition is smaller.

According to a second aspect of the present invention, a management apparatus for managing a communication device includes an identifying table storing unit operable to store an identifying table having an identifying condition for determining a type of the communication device. The identifying condition corresponds to a monitoring method for monitoring a status of the communication device satisfying the identifying condition. An identifying unit is operable to determine whether or not the communication device satisfies the identifying condition; and a monitoring unit is operable to monitor the status of the communication device by using the monitoring method that corresponds to the identifying condition, in a case where the communication device satisfies the identifying condition.

According to a third aspect of the present invention, a program, stored in a computer-readable medium, for use with a management apparatus for managing a communication device includes an identifying table storing unit that operates in a computer to store an identifying table having an identifying condition for determining a type of the communication device. The identifying condition corresponds to a check method for determining a function of the communication device that satisfies the identifying condition. An identifying unit operates to determine whether or not the communication device satisfies the identifying condition; and a check unit operates to determine the function of the communication device by using the check method that corresponds to the identifying condition, in a case where the communication device satisfies the identifying condition.

According to a fourth aspect of the present invention, a program, stored in a computer-readable medium, for use with a management apparatus for managing a communication device includes an identifying table storing unit that operates to store an identifying table having an identifying condition for determining a type of the communication device. The identifying condition corresponds to a monitoring method for monitoring a status of the communication device satisfying the identifying condition. An identifying unit operates to determine whether or not the communication device satisfies the identifying condition; and a monitoring unit operates to monitor the status of the communication device by using the monitoring method corresponding to the identifying condition, in a case where the communication device satisfies the identifying condition.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 illustrates a structure of a network system according to an embodiment of the present invention.

FIG. 2 illustrates a structure of a management apparatus according to one embodiment of the present invention.

FIG. 3 shows an exemplary identifying table stored in an identifying table storing unit according to one embodiment of the present invention.

FIG. 4 shows an exemplary check table stored for each type of communication device in a check table storing unit according to one embodiment of the present invention.

FIG. 5 shows an exemplary monitoring table stored in a monitoring table storing unit according to one embodiment of the present invention.

FIG. 6 shows an exemplary communication device database stored in a communication device database storing unit according to one embodiment of the present invention.

FIG. 7 shows a management flow of the network system by the management apparatus according to one embodiment of the present invention.

FIG. 8 shows an exemplary flow of an identification operation for a communication device by an identifying unit according to one embodiment of the present invention.

FIG. 9 shows an exemplary flow of a check operation for the communication device by a check unit according to one embodiment of the present invention.

FIG. 10 shows an exemplary flow of a monitoring operation for the communication device by a monitoring unit according to one embodiment of the present invention.

FIG. 11 shows an input flow of an identifying condition by the management apparatus according to one embodiment of the present invention.

FIG. 12 shows an exemplary screen on a display according to one embodiment of the present invention.

FIG. 13 illustrates a hardware configuration of a management apparatus according to one embodiment of the present invention.

### DETAILED DESCRIPTION

The invention will now be described based on the preferred embodiments, which do not intend to limit the scope of the present invention, but exemplify the invention. All of the features and the combinations thereof described in the embodiments are not necessarily essential to the invention.

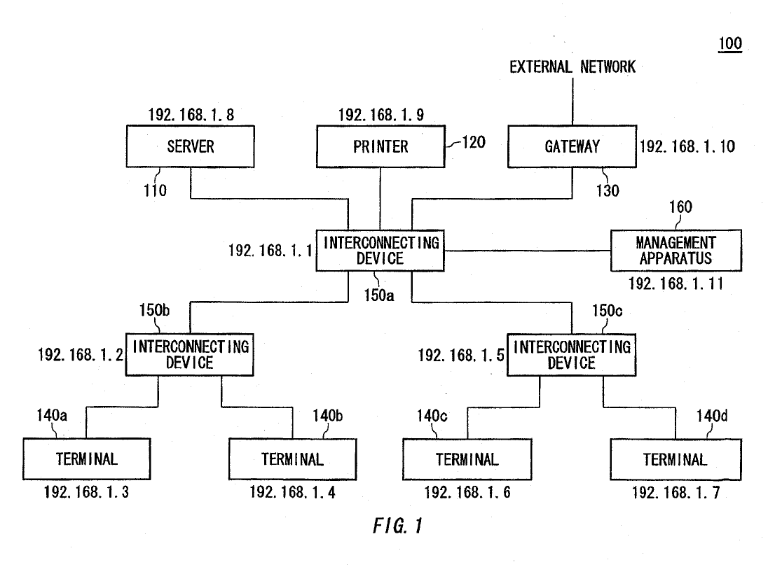

FIG. 1 illustrates a configuration of a network system 100 according to an embodiment of the present invention. The network system 100 includes a server 110, a printer 120, a gateway 130, terminals 140a, 140b, 140c and 140d, interconnecting devices 150a, 150b and 150c and a management apparatus 160. The server 110, the printer 120, the gateway 130, the terminals 140a, 140b, 140c and 140d, the interconnecting devices 150a, 150b and 150c and the management apparatus 160 according to this embodiment are exemplary communication devices according to the present invention.

The server 110 provides various services including file management, mail management, printer management and/or database management to the terminals 140a, 140b, 140c and 140d. The printer 120 performs printing when receiving a request from any of the terminals 140a, 140b, 140c and 140d. The gateway 130 provides interconnections in a case where any of the server 110, the terminals 140a, 140b, 140c and 140d and the management apparatus 160 accesses an external network. Each of the terminals 140a, 140b, 140c and 140d is used for access by a user to any of the server 110, the printer 120, the gateway 130 and the like, and may be a personal computer or a PDA (Personal Digital Assistant), for example. The interconnecting devices 150a, 150b and 150c connect the server 110, the printer 120, the gateway 130, the terminals 140a, 140b, 140c and 140d and the management apparatus 160 to each other, thereby interconnecting communication between those communication devices.

The management apparatus 160 manages the communication devices in the network system 100, that is, the server 110, the printer 120, the gateway 130, the terminals 140a, 140b, 140c and 140d and the interconnecting devices 150a, 150b and 150c. More specifically, the management apparatus 160 performs operations including an identification operation for identifying a type of a communication device in the network system 100, a check operation for identifying a function of the communication device in the network system 100 and a monitoring operation for monitoring a status of the communication device in the network system 100.

In the present embodiment, it is assumed that IP addresses from “192. 168. 1. 1” to “192. 168. 1. 11” are assigned to the respective communication devices, as shown in FIG. 1.

In the following, for convenience the description will be made assuming that the network system 100 of the present embodiment is a local area network. However, the network system 100 may be a public communication network, such as the Internet or a public phone network, various dedicated networks, such as a local area network, or a combination thereof.

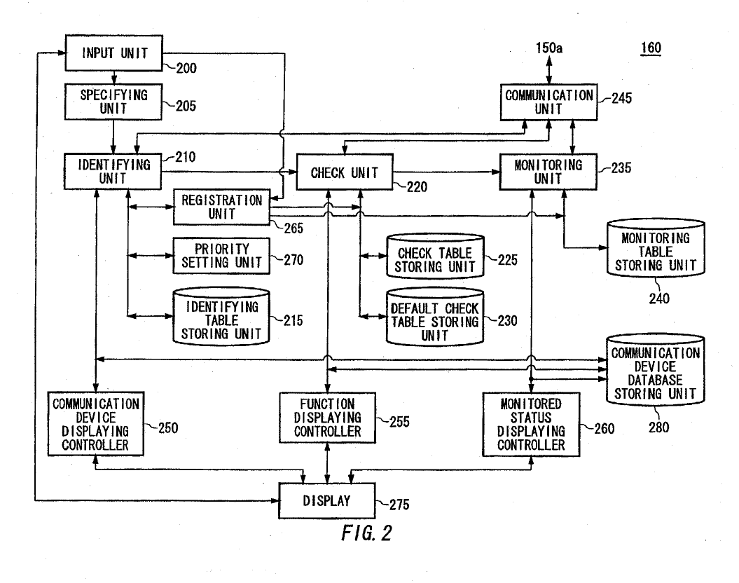

FIG. 2 illustrates a structure of the management apparatus 160 according to an embodiment of the present invention. The management apparatus 160 includes an input unit 200, a specifying unit 205, an identifying unit 210, an identifying table storing unit 215, a check unit 220, a check table storing unit 225, a default check table storing unit 230, a monitoring unit 235, a monitoring table storing unit 240, a communication unit 245, a communication device database storing unit 280, a communication device displaying controller 250, a function displaying controller 255, a monitored status displaying controller 260, a display 275, a registration unit 265 and a priority setting unit 270.

The input unit 200 allows a user of the management apparatus 160 to input parameters required when the management apparatus 160 performs various operations. In other words, the input unit 200 allows the user of the management apparatus 160 to input information for specifying a communication device for which the operation is to be performed when the identification operation, the check operation and/or the monitoring operation is performed. Moreover, the input unit 200 allows the user of the management apparatus 160 to input information for modifying an identification table stored in the identifying table storing unit 215, that is to be used in the identification operation for the communication device. Similarly, the input unit 200 allows the user of the management apparatus 160 to input information for modifying check tables, which are prepared for respective types of communication devices, stored in the check table storing unit 225, that are to be used in the check operation for the communication device, and/or information for modifying a default check table stored in the default check table storing unit 230. Furthermore, the input unit 200 allows the user of the management apparatus 160 to input information for modifying a monitoring table stored in the monitoring table storing unit 240, that is to be used in the monitoring operation for the communication device.

The specifying unit 205 makes the user of the management apparatus 160 specify a target communication device by means of the input unit 200. The specifying unit 205 then transmits an address of the specified communication device to the check unit 220, via the identifying unit 210, so as to make the check unit 220 determine the type and function of the target communication device. As described above, the specifying unit 205 can begin the identification operation and the check operation for the communication device specified by the user of the management apparatus 160.

The identifying unit 210 performs the identification operation for determining the type of the communication device based on the identification table stored in the identifying table storing unit 215. The identifying unit 210 then stores the result of the identification operation in the communication device database storing unit 280. The check unit 220 performs the check operation for the communication device for which the type was determined by the identifying unit 210 based on the check tables stored for the respective types of communication devices in the check table storing unit 225, and the default check table stored in the default check table storing unit 230. The check unit 220 then stores the result of the check operation in the communication device database storing unit 280. The monitoring unit 235 performs the monitoring operation for the communication device for which the type was determined by the identifying unit 210 based on the monitoring table stored in the monitoring table storing unit 240. The monitoring unit 235 then stores the result of the monitoring operation in the communication device database storing unit 280. The communication unit 245 handles communication between the identifying unit 210, check unit 220 and monitoring unit 235 and the communication devices in the network system 100. The communication device database storing unit 280 stores a communication device database in which the results of the identification operation, check operation and monitoring operation, performed by the identifying unit 210, check unit 220 and monitoring unit 235, respectively, are registered.

The communication device displaying controller 250 allows the display 275 to display an image corresponding to the communication device for which the identification operation was performed by the identifying unit 210, depending on the type of the communication device that was determined by the identifying unit 210. Thus, the user of the management apparatus 160 can identify the type of the communication device based on the image of the communication device displayed on the display 275. The function displaying controller 255 obtains the function of the target communication device that was determined in the check operation by the check unit 220 from the communication device database and displays it on the display 275. When the user of the management apparatus 160 performs a predetermined operation for the image of the communication device displayed by the communication device displaying controller 250, for example, selecting the image by clicking it, the function displaying controller 255 allows the function of the communication device for which the predetermined operation was performed to be displayed. The monitored status displaying controller 260 obtains the status of the target communication device acquired in the monitoring operation by the monitoring unit 235 from the communication device database and displays it on the display 275. The display 275 displays the image on a screen of the management apparatus 160 in accordance with instruction(s) from the communication device displaying controller 250, the function displaying controller 255 and/or the monitored status displaying controller 260.

When the registration unit 265 received the information for modifying the identifying table stored in the identifying table storing unit 215, the check tables stored for the respective types of communication devices in the check table storing unit 225, the default check table stored in the default check table storing unit 230, or the monitoring table stored in the monitoring table storing unit 240, the registration unit 265 modifies the corresponding table. The priority setting unit 270 sets the priority for a plurality of identifying conditions stored in the identifying table, for example, in a case where the identifying table stored in the identifying table storing unit 215 was modified.

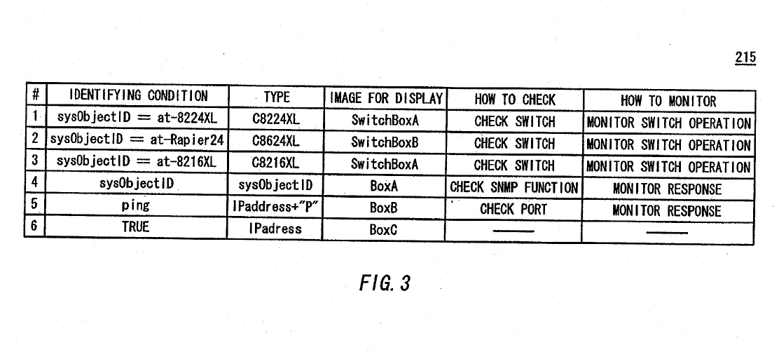

FIG. 3 shows an exemplary identifying table stored in the identifying table storing unit 215 according to one embodiment of the present invention. The identifying table has fields of identifying condition, type, image for display, how to check and how to monitor.

The identifying condition field stores identifying conditions for determining the type of the target communication device. The type field stores the type of communication device that satisfies the corresponding identifying condition. The field of “image for display” stores a name of an image used for display on the display 275 when the communication device displaying controller 250 displays the image of the communication device satisfying the corresponding identifying condition. The field of “how to check” stores a check method for checking the function of the communication device satisfying the corresponding identifying condition. The field of how to monitor stores a monitoring method for monitoring the status of the communication device satisfying the corresponding identifying condition.

The identifying table includes a plurality of sets of identifying condition, type and check method, as shown in FIG. 3. Those sets have priorities so that the priority of the set in the upper row is higher than that of the set in the lower row.

The identifying unit 210 receives the address of the target communication device from the specifying unit 205 and then performs the identification operation. In the identification operation, the identifying unit 210 selects the identifying table that is specified, for example, by the user of the management apparatus 160 via the input unit 200, from one or more identifying tables stored in the identifying table storing unit 215. Alternatively, the identifying unit 210 may determine the type of the target communication device by accessing a plurality of identifying tables one after another. Next, the identifying unit 210 acquires the respective sets stored in the selected identifying table in an order from the highest priority to the lowest priority. Then, the identifying unit 210 determines which one of the sets in the identifying table includes the identifying condition that is satisfied by the target communication device, for the respective sets in the identifying table one by one in the order from the set of the highest priority to the set of the lower priority. At a time when the target communication device satisfied the identifying condition stored in the identifying condition field of one of the sets, the identifying unit 210 obtains the type corresponding to the identifying condition, thereby determining the type of the target communication device.

For example, for each of the first, second and third rows, the identifying unit 210 determines that the target communication device satisfies the identifying condition in that row in a case where sysObjectID parameter held by the target communication device is coincident with a value on the right side of the identifying condition. The sysObjectID parameter in this example is information describing a name of a type of the communication device stored in MIB (Management Information Base) provided in SNMP (Simple Network Management Protocol) function of the communication device, for example. The identifying unit 210 transmits GET REQUEST message of SNMP to the target communication device, for example, via the communication unit 245 and then acquires sysObjectID parameter. In a case where the type name identified by sysObjectID parameter is “at-8224XL”, “at-Rapier24” or “at-8216XL”, the identifying unit 210 determines the type of the communication device to be “C8224XL”, “C8624XL” or “C8216XL”.

For the fourth row of the table shown in FIG. 3, the identifying unit 210 determines that the target communication device satisfies the identifying condition in the fourth row in a case where it was able to acquire sysObjectID parameter held by the target communication device. For the fifth row of the table shown in FIG. 3, the identifying unit 210 determines that the target communication device satisfies the identifying condition in the fifth row in a case where the target communication device responded to ping command. For the sixth row of the table shown in FIG. 3, the identifying unit 210 determines that the target communication device always satisfies the identifying condition.

After determining the type of the target communication device in the aforementioned manner, the identifying unit 210 transmits the address of the target communication device and the check method associated with the satisfied identifying condition to the check unit 220, so as to make the check unit 220 perform the check operation. Similarly, the identifying unit 210 transmits the address of the target communication device and the monitoring method associated with the satisfied identifying condition to the monitoring unit 235, via the check unit 220, so as to cause the monitoring unit 235 to perform the monitoring operation. Moreover, the identifying unit 210 stores the address, type name of image for display and the like of the target communication device in the communication device database in the communication device database storing unit 280.

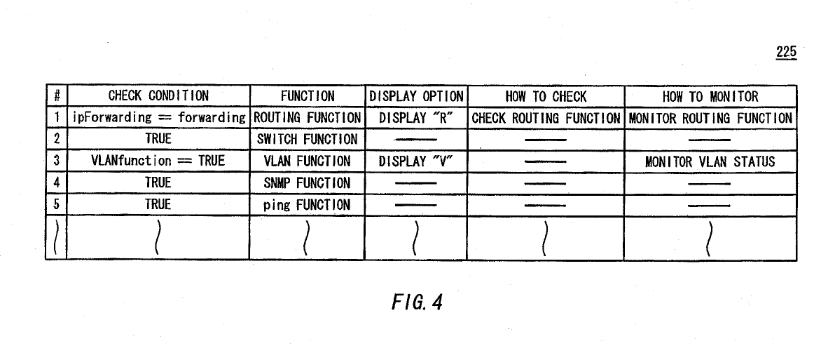

FIG. 4 shows an exemplary check table stored for each type of communication device in the check table storing unit 225 according to one embodiment of the present invention. The check table shown in FIG. 4 corresponds to a case where the check method in FIG. 3 is “check switch”. The check table has fields of check condition, function, display option, how to check, and how to monitor.

The check condition field stores a check condition for determining the function of the target communication device. The function field stores the function determined by the corresponding check condition. The display option field stores information to be added to the image of the communication device displayed on the display 275 in a case where the target communication device satisfies the corresponding check condition. The field of “how to check” stores a check method for checking the communication device in more detail, in a case where the communication device satisfies the corresponding check condition. The field of “how to monitor” stores a monitoring method for monitoring the communication device in more detail, in addition to the monitoring method specified by the identifying table in the identifying table storing unit 215, in a case where the communication device satisfies the corresponding check condition.

The default check table storing unit 230 stores a default check table having approximately the same format as the check table stored for each type of communication device.

The check unit 220 receives the address of the target communication device and the check method associated with the satisfied identifying condition from the identifying unit 210. The check unit 220 then performs the check operation for the target communication device. The check operation performed here is classified into a default check operation and a check operation depending on the type of the communication device.

The default check operation is performed independently of the type of the communication device determined by the identifying unit 210. The check unit 220 performs the default check operation by using the default check table in the default check table storing unit 230.

The check operation depending on the type of the communication device is performed by using the check method corresponding to the type of the communication device determined by the identifying unit 210. The check unit 220 selects the check table specified by the check method received from the identifying unit 210 from one or more check tables stored in the check table storing unit 225 depending on the types of the communication devices, and then performs the check operation depending on the type of the communication device by using the selected check table.

In the default check operation or the check operation depending on the type of the communication device, the check unit 220 acquires the respective rows stored in the check table (default check table or check table depending on the type of the communication device) one by one. The check unit 220 then determines whether or not the target communication device satisfies the check condition in the acquired row. In a case where the communication device satisfies the check condition in the acquired row, the check unit 220 determines that the communication device has the function corresponding to the satisfied check condition.

For example, for the first row of the table shown in FIG. 4, the check unit 220 determines that the communication device satisfies the check condition in the first row in a case where ipForwarding parameter held by the target communication device is coincident with a value on the right side of the check condition. Here, ipForwarding parameter is information indicating the presence or absence of a routing function of the communication device, that is stored in MIB provided in SNMP function of the communication device, for example. The check unit 220 transmits GET REQUEST message of SNMP to the target communication device, via the communication unit 245, for example, thereby acquiring ipForwarding parameter. The check unit 220 then determines that the communication device has routing function in a case where ipForwarding parameter is “forwarding”.

Similarly, for the third row of the table shown in FIG. 4, the check unit 220 determines that the communication device has VLAN function in a case where VLAN function parameter held by the target communication device is “true”. For the second, fourth and fifth rows of the table shown in FIG. 4, the check unit 220 determines that the communication device for which the check operation is to be performed always has a switch function, SNMP function and ping function, respectively.

After determining the function of the communication device in the aforementioned manner, in a case where the check table specifies a more detailed check method corresponding to the determined function, the check unit 220 acquires the check table corresponding to the specified check method from the check table storing unit 225, and then performs the more detailed check operation in a similar manner to that described above. Then, in a case where the communication device satisfies the check condition, the check unit 220 acquires the monitoring method corresponding to the satisfied check condition in the check table, and adds it to the monitoring method received from the identifying unit 210. The check unit 220 then transmits the address of the target communication device and the monitoring method(s) acquired by the identifying unit 210 and the check unit 220 to the monitoring unit 235, thereby causing the monitoring unit 235 to perform the monitoring operation.

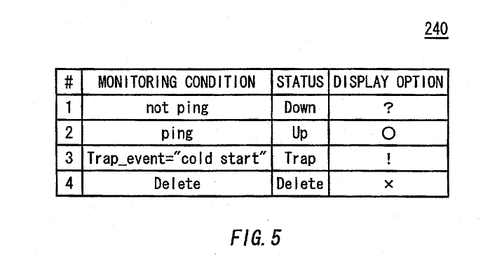

FIG. 5 shows an exemplary monitoring table stored in the monitoring table storing unit 240 according to one embodiment of the present invention. The monitoring table shown in FIG. 5 corresponds to a case where the monitoring method in FIG. 3 is “monitor switch operation”. The monitoring table has fields of monitoring condition, status, and display option.

The monitoring condition field stores a monitoring condition for monitoring the status of the target communication device. The status field stores the status of the communication device in a case where the communication device satisfies the corresponding monitoring condition. The display option field stores information to be added to the image of the communication device to be displayed on the display 275 in a case where the communication device satisfies the corresponding monitoring condition.

The monitoring unit 235 receives the address of the target communication device and the monitoring method associated with the satisfied identifying condition and/or check condition from the check unit 220. The monitoring unit 235 then monitors the status of the target communication device. More specifically, the monitoring unit 235 selects the monitoring table specified by the monitoring method received from the check unit 220 from one or more monitoring tables stored in the monitoring table storing unit 240 and performs the monitoring operation depending on the type and function of the communication device by using the selected monitoring table.

In the monitoring operation, the monitoring unit 235 acquires the respective rows in the monitoring table one by one. Then, the monitoring unit 235 determines whether or not the target communication device satisfies the monitoring condition in the acquired row. In a case where the communication device satisfies the monitoring condition, the monitoring unit 235 determines that the communication device has the status corresponding to the monitoring condition.

For example, for the first or second row of the table shown in FIG. 5, the monitoring unit 235 determines that the communication device is in DOWN state or UP state in a case where the communication device does not respond or responds to ping command. For the third row of the table in FIG. 5, the monitoring unit 235 determines that the communication device is in Trap state in a case where Trap message of SNMP or the like, that was received from the target communication device, was a message notifying “cold start” event that indicates reset of the communication device. For the fourth row of the table shown in FIG. 5, the monitoring unit 235 determines that the communication device is in a state where the communication device was deleted from the network system 100 (Delete state), for example, in a case where the communication device did not respond to ping command for 10 days.

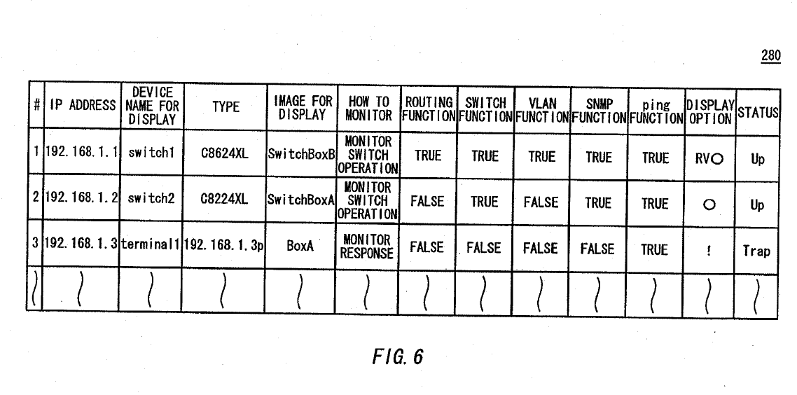

FIG. 6 shows an exemplary communication device database stored in the communication device database storing unit 280 according to one embodiment of the present invention. The communication device database includes fields of IP address, device name for display, type, image for display, how to monitor, routing function, switch function, VLAN function, SNMP function, PING function, status, and display option.

The IP address field is used for storing the address of the communication device for which the identifying unit 210 performed the identification operation. In the present embodiment, the address of the communication device is an IP address, for example. The field of “device name for display” is used when the identifying unit 210 acquires and stores the name that was assigned to the target communication device by the user of the management apparatus 160. The identifying unit 210 may acquire, as the name to be stored in the field of “device name for display”, a name registered in DNS (Domain Name Service) function of the server 110, for example. The type field is used when the identifying unit 210 stores the type of the communication device determined in the identification operation. The field of “image for display” is used when the identifying unit 210 stores the name of the image of the communication device determined in the identification operation. The field of “how to monitor” is used for storing the monitoring method for monitoring the status of the communication device by the monitoring unit 235. The routing function field, the switch function field, the VLAN function field, the SNMP function field, and PING function field are used for storing by the check unit 220 the presence or absence of the corresponding functions of the communication device that were determined in the check operation. The status field is used for storing by the monitoring unit 235 the status of the communication device acquired in the monitoring operation. The display option field is used for storing by the check unit 220 the display option acquired in the check operation from the check table in the check table storing unit 225 or the default check table storing unit 230 and storing by the monitoring unit 235 the display option acquired from the monitoring table in the monitoring table storing unit 240 by the monitoring operation.

The identifying unit 210, the check unit 220 and the monitoring unit 235 store the results of the identification operation, check operation and monitoring operation, respectively, in the communication device database in the communication device database storing unit 280. The communication device displaying controller 250, the function displaying controller 255, and the monitored status displaying controller 260 acquire information related to the communication device from the communication device database in the communication device database storing unit 280 when displaying the results of the identification operation, check operation and monitoring operation on the display 275.

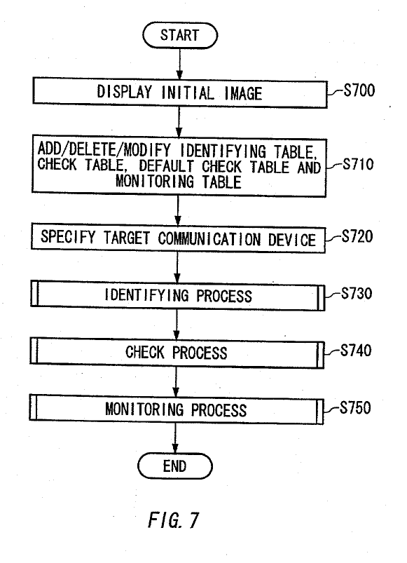

FIG. 7 shows a management flow of the network system 100 by the management apparatus 160 according to one embodiment of the present invention. First, the display 275 displays an initial image (Step S700). The display 275 displays information related to communication devices in the network system 100 by using the communication device displaying controller 250, the function displaying controller 255 and the monitored status displaying controller 260 based on information that has been stored in the communication device database storing unit 280 at a time of Step S700. Then, the registration unit 265 updates the identification table, the check tables stored depending on the types of the communication devices, the default check table and/or the monitoring table in a case where an instruction of addition, deletion, modification or the like for a table was received from the input unit 200 (Step S710). The specifying unit 205 then prompts the user of the management apparatus 160 to specify a target communication device by means of the input unit 200 (Step 720). The identifying unit 210 then performs the identification operation for the communication device specified by the specifying unit 205 (Step S730). The check unit 220 then performs the check operation for the communication device specified by the specifying unit 205 (Step S740). The monitoring unit 235 then performs the monitoring operation for the communication device specified by the specifying unit 205 (Step S750).

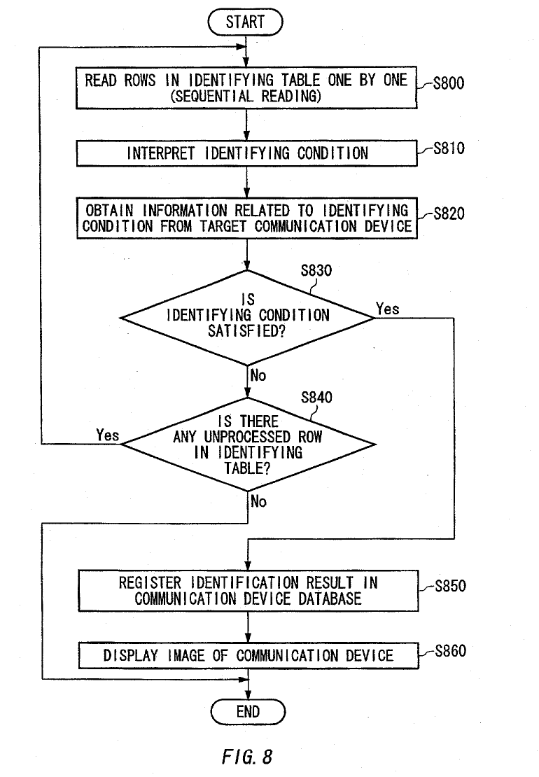

FIG. 8 shows a flow of the identification operation for the communication device by the identifying unit 210 according to one embodiment of the present invention. First, the identifying unit 210 reads the respective rows in the selected identifying table in the identifying table storing unit 215 one by one from the top to the bottom (Step S800). The identifying unit 210 then interprets the identifying condition in the row read in Step S800 (Step S810). The identifying unit 210 then acquires information in the communication device used for determination of the identifying condition by using, for example, GET REQUEST message of SNMP (Step S820). Then, the identifying unit 210 determines whether or not the identifying condition is satisfied (Step S830). In a case where the identifying condition is satisfied, the identifying unit 210 stops the determination of the identifying condition stored in the succeeding rows in the identifying table, and the flow goes to Step S850.

In a case where the identifying condition is not satisfied in Step S830, the identifying unit 210 determines whether or not there is any unprocessed row remaining in the identifying table (Step S840). If an unprocessed row remains in the identifying table, the flow goes to Step S800 and the identifying unit 210 reads the next row (Step S800). In a case where there is no unprocessed row in the identifying table in Step S840, the identifying unit 210 finishes the identification operation without determining the type of the target communication device.

In a case where the identifying condition was determined to be satisfied in Step S830, the identifying unit 210 acquires the device name for display of the communication device from the server 110 and also acquires the type corresponding to the satisfied identifying condition from the identifying table. The identifying unit 210 then stores the address, the device name for display and the type of the communication device in the communication device database (Step S850). Next, the communication device displaying controller 250 makes the display 275 display the target communication device on its screen by using the image corresponding to the type stored by the identifying unit 210 in the communication device database (Step S860).

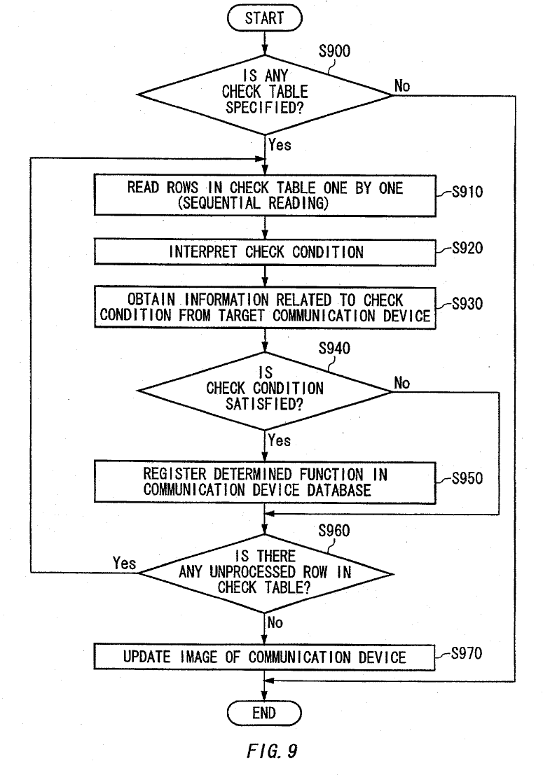

FIG. 9 shows a flow of the check operation for the communication device by the check unit 220 according to one embodiment of the present invention. The check operation flow shown in FIG. 9 is performed in each of the default check operation and the check operation depending on the type of the communication device.

First, the check unit 220 finishes the check operation in a case where the check method received from the identifying unit 210 specifies no check table (Step S900). Here, the check unit 220 performs the check operation using the default check table irrespective of the type of the communication device. Then, the check unit 220 reads the respective rows in the selected check table to be processed one by one (Step S910). The check unit 220 then interprets the check condition in the row read in Step S910 (Step S920). The check unit 220 then acquires information in the communication device used for determination of the check condition by using, for example, GET REQUEST message of SNMP (Step S930).

The check unit 220 then determines whether or not the check condition is satisfied (Step S940). If the check condition is satisfied, the check unit 220 stores the function of the communication device corresponding to the satisfied check condition in the communication device database (Step S950). Then, in a case where there is a next row in the check table to be processed, the flow goes to Step S910 and the check unit 220 reads the next row in the check table (Step S960). When the processes in Steps S900 to S960 are finished, the function displaying controller 255 adds information specified by the display option corresponding to the satisfied check condition to the image of the target communication device displayed on the display 275 (Step S970).

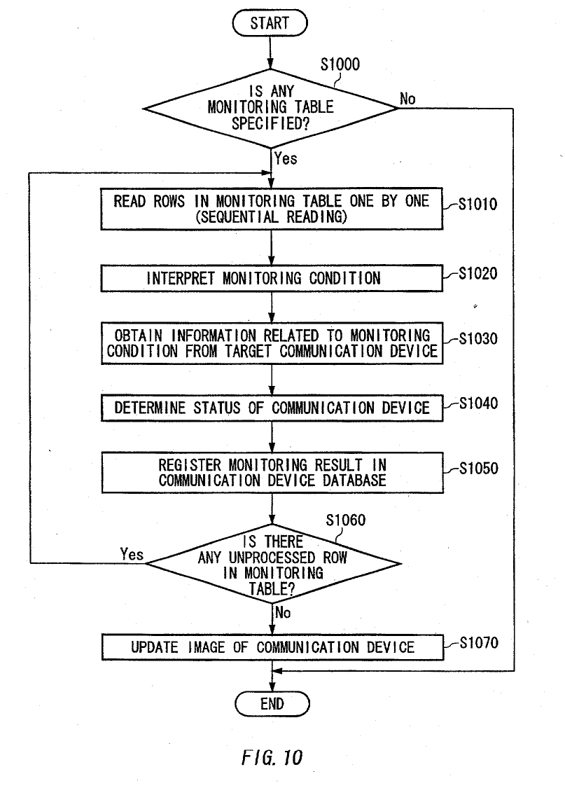

FIG. 10 shows an exemplary flow of the monitoring operation for the communication device by the monitoring unit 235 according to one embodiment of the present invention. The monitoring operation flow shown in FIG. 10 is performed in each monitoring operation corresponding to the monitoring method(s) received from the identifying unit 210 and the check unit 220.

First, the monitoring unit 235 finishes the monitoring operation in a case where the monitoring method(s) received from the identifying unit 210 and the check unit 220 specifies/specify no monitoring table (Step S1000). The monitoring unit 235 then reads the respective rows in the selected monitoring table to be processed one by one (Step S1010). The monitoring unit 235 then interprets the monitoring condition in the row read in Step S1010 (Step S1020). The monitoring unit 235 acquires information in the communication device used for determination of the monitoring condition by transmitting GET REQUEST message of SNMP, receiving Trap message or the like (Step S1030).

The monitoring unit 235 then determines whether or not the monitoring condition is satisfied so as to determine the status of the communication device (Step S1040). The monitoring unit 235 then stores the status of the communication device corresponding to the satisfied monitoring condition in the communication device database (Step S1050). If there is a next row in the monitoring table to be processed, the flow goes to Step S1010 and the monitoring unit 235 reads the next row in the monitoring table to be processed (Step S1060). When the processes in Steps S1000 to S1060 are finished, the monitored status displaying controller 260 adds an image specified by the image for display corresponding to the satisfied monitoring condition to the image of the target communication device displayed on the display 275 (Step S1070).

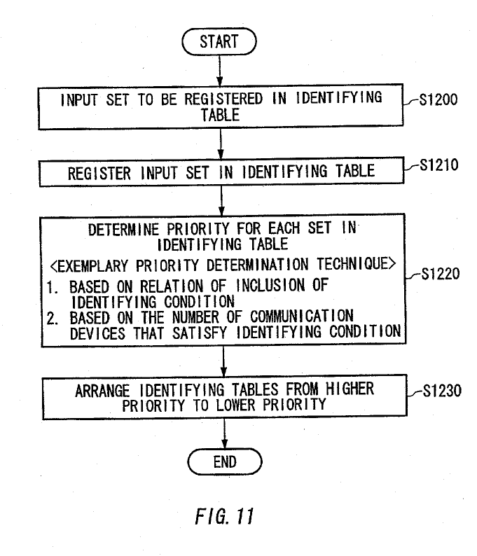

FIG. 11 shows an input flow of the identifying condition by the management apparatus 160 according to one embodiment of the present invention. The input flow of the identifying condition shown in FIG. 11 is performed in a case where the user of the management apparatus 160 adds a set of an identifying condition, a type and a check method of the communication device to the identifying table in Step S710 in FIG. 7 or a case where the identifying condition for the communication device is modified.

First, the input unit 200 allows the user of the management apparatus 160 to input a set to be registered in the identifying table (Step S1200). Then, the registration unit 265 registers the set input by the input unit 200 in the identifying table in the identifying table storing unit 215 (Step S1210). Then, the priority setting unit 270 determines priorities for a plurality of sets registered in the identifying table, that include the set added or modified in Step S1210, based on the identifying conditions included in the respective sets (Step S1220). Then, the priority setting unit 270 arranges the sets in an order from the highest priority to the lowest priority in the identifying table, thereby setting the priorities for the respective sets registered in the identifying table (Step S1230).

The priority setting unit 270 uses any one of the following methods in Step S1220, for example.

(1) Determine priorities for the respective sets based on relationships of inclusiveness between the identifying conditions.

The narrower identifying information can determine the type of the communication device in more detail. For example, the identifying condition in the first row of the table in FIG. 3, “sysObjectID=at-8224XL”, means that a communication device has sysObjectiD parameter and the type name of the communication device specified that the sysObjectID parameter is “at-8224XL”. On the other hand, the identifying condition in the fourth row in FIG. 3, “sysObjectID”, means that a communication device has sysObjectID parameter and therefore includes the identifying condition in the first row. Moreover, the identifying condition in the first row can determine the type name of the communication device whereas the identifying condition in the fourth row only defines the communication device with SNMP function. Thus, the identifying condition in the fourth row is broader than that in the first row. Assuming that the higher priority is assigned to the identifying condition in the fourth row than the priority for the identifying condition in the first row, the identifying unit 210 determines the identifying condition in the fourth row prior to that in the first row. In this case, the identifying unit 210 cannot determine the type name for the communication device having the type name of “at-8224XL”.

Accordingly, in a case where the first one of two identifying conditions is included in the second one, the priority setting unit 270 sets the priority for the set corresponding to the first identifying condition to be higher than the priority for the set corresponding to the second identifying condition. Thus, the identifying unit 210 can determine the type of the communication device by using an identifying table that is as detailed as possible.

In the above process, the priority setting unit 270 may set relations of inclusiveness on the basis of different information, such as a relationship of inclusiveness between sysObjectID parameter and ping command, based on data indicating relations of inclusiveness between several kinds of information which is predetermined in advance. More specifically, in the relation of inclusion between sysObjectID parameter and ping command, for example, when there is an assumption that a communication device having SNMP function always responds to ping command, or the like, the priority setting unit 270 can hold setting data indicating that an identifying condition that the communication device has sysObjectID parameter is included in an identifying condition that the communication device responds to ping command.

(2) Determine priorities for respective sets based on the number of communication devices satisfying corresponding identifying conditions.

In a case where an addition and/or a modification is made to an identifying table, the priority setting unit 270 counts, for every identifying condition, the number of communication devices in the network system 100 that satisfy that identifying condition, instead of performing the determination as set forth at foregoing paragraph(1). Then, the priority setting unit 270 determines that the identifying condition for which the counted number is smaller is narrower, so as to set priorities for the identifying conditions in such a manner that the priority for the identifying condition for which the counted number is smaller is higher.

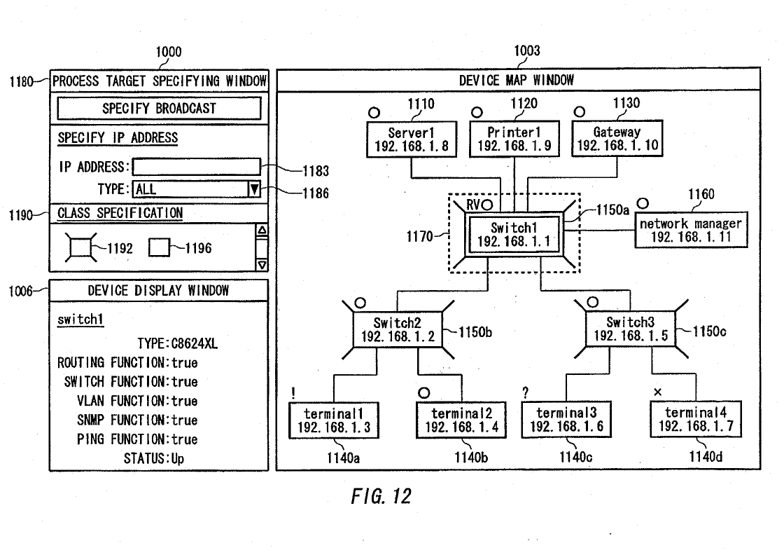

FIG. 12 illustrates an exemplary screen on the display 275 according to one embodiment of the present invention. This screen of the display 275 contains a process target specifying window 1000, a device map window 1003 and a device display window 1006.

The process target specifying window 1000 allows the user of the management apparatus 160 to input information for determining a target communication device, via the input unit 200, when the identification operation, check operation and/or monitoring operation are/is performed. The process target specifying window 1000 has a broadcast specifying button 1180, an IP address specifying area 1183, a type specifying area 1186 and a class specifying area 1190. The broadcast specifying button 1180 is a button for inputting an instruction to the management apparatus 160 to perform the identification operation, check operation and/or monitoring operation for all the communication devices in the network system 100. The IP address specifying area 1183 is used for inputting one or more addresses of target communication devices for which the identification operation, check operation and/or monitoring operation is to be performed. The user of the management apparatus 160 can specify one or more communication devices as a target of the operation by inputting “192. 168. 1. 1” (specifying a single address) or “192. 168. 1.*” (specifying a plurality of addresses where * is an arbitrary value), for example, in the IP address specifying area 1183. The type specifying area 1186 is used for specifying a type of the target communication device. The identifying unit 210 causes the check unit 220 and/or the monitoring unit 235 to perform the check operation and/or the monitoring operation, respectively, only in a case where, as a result of the identification operation, the type of the target communication device was determined to be the type specified in the type specifying area 1186.

The class specifying area 1190 is used for operating the identifying table, the check table and the monitoring table by using icons. In the class specifying area 1190, the identifying table, the check table and the monitoring table are shown by identifying class icons, check class icons, and monitoring class icons, respectively. An interconnecting device identifying class icon 1192 and a communication node identifying class icon 1196 are exemplary identifying class icons. The interconnecting device identifying class icon 1192 is an icon for the identifying table that is prepared for identifying types of interconnecting devices. The communication node identifying class icon 1196 is an icon indicating the identifying table for identifying types of communication nodes that are communication devices, other than the interconnecting devices.

The user of the management apparatus 160 may specify the target communication device and the identifying table for identifying that communication device by using the interconnecting device identifying class icon 1192, the communication node identifying class icon 1196 or the like. More specifically, when the user of the management apparatus 160 drags the interconnecting device identifying class icon 1192 to the device map window 1003 and drops it there, for example, the input unit 200 causes an input window to pop-up on the display 275, which is similar to the IP address specifying area 1183, for allowing the input of the address of the target communication device. The identifying unit 210 then performs the identification operation for the communication device having the address specified in that input screen, with the identifying table specified by the interconnecting device identifying class icon 1192.

The device map window 1003 shows a server object 1110, a printer object 1120, a gateway object 1130, terminal objects 1140a, 1140b, 1140c and 1140d, switch objects 1150a, 1150b and 1150c and a management apparatus object 1160 so as to correspond to the respective communication devices in the network system 100 (see FIG. 1). More specifically, the communication device displaying controller 250, the function displaying controller 255 and the monitored status displaying controller 260 display the objects corresponding to those communication devices based on the addresses, names for display, images for display and display options of the target communication devices that were acquired from the communication device database stored in the communication device database storing unit 280. Moreover, in a case where a certain object corresponding to a communication device was selected by means of a keyboard, a mouse or the like, the device map window 1003 shows the object of the selected communication device by a selecting cursor 1170.

In a case where the user of the management apparatus 160 selected a certain image in the device map window 1003 by means of the selecting cursor 1170, the device display window 1006 shows the function and the like of the communication device corresponding to the selected image, acquired by the check unit 220. For example, in the example shown in FIG. 12, the switch object 1150a is selected by means of the selecting cursor 1170. Thus, the function displaying controller 255 displays the function of the switch object 1150a in the device display window 1106. Similarly, the communication device displaying controller 250 and the monitored status displaying controller 260 display the type and status of the switch object 1150a selected by the selecting cursor 1170 in the device display window 1006.

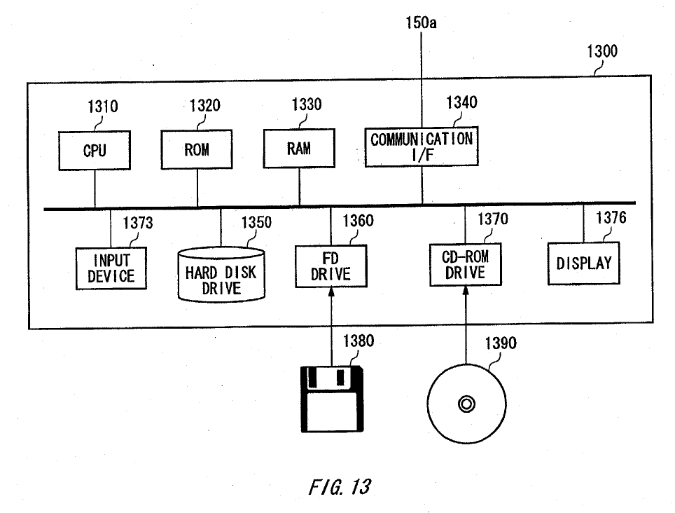

FIG. 13 illustrates an exemplary hardware configuration of the management apparatus 160 according to one embodiment of the present invention. The functions of the management apparatus 160 are realized by cooperation of a computer 1300, including a CPU 1310; a ROM 1320; a RAM 1330; a communication interface 1340; a hard disk drive 1350; an input device 1373; and a display 1376, and at least one program executed on the computer 1300. The computer 1300 may further include a floppy disk drive 1360 and/or a CD-ROM drive 1370.

The program for realizing the management apparatus 160 includes an input module, a specifying module, an identifying module, a check module, a monitoring module, a communication module, a communication device displaying module, a function displaying module, a monitored status displaying module, a registration module, a priority setting module and a display module. These modules are programs for making the computer 1300 operate as the input unit 200, the specifying unit 205, the identifying unit 210, the check unit 220, the monitoring unit 235, the communication unit 245, the communication device displaying controller 250, the function displaying controller 255, the monitored status displaying controller 260, the registration unit 265, the priority setting unit 270 and the display 275. Moreover, the hard disk drive 1350 may be used as the identifying table storing unit 215, the check table storing unit 225, the default check table storing unit 230, the monitoring table storing unit 240 and the communication device database storing unit 280. In this case, the identifying table, the check table for each type of communication device, the default check table, the monitoring table and/or the communication device database may be stored as a file or files on the hard disk drive 1350.

The aforementioned program may be stored in an external storage medium. As the storage medium, other than a floppy disk 1380 and a CD-ROM 1390, an optical recording medium, such as a DVD or a PD, a magneto-optical recording medium, such as an MD, a tape-like medium, or a semiconductor memory, such as an IC card, can be used. Moreover, a storage device such as a hard disk or a RAM provided in a server system connected to an exclusive communication network or the Internet may be used as the storage medium, so that the program can be provided to the computer 1300 through an external network or a network connected to the computer 1300.

As described above, according to a management apparatus of the present invention, management functionality can be provided in which management of a network system is classified into an identification operation, check operation and monitoring operation, and which can easily be found by a user of the management apparatus. Moreover, by showing the combined results of these operations on a display, it is possible to show the results of these operations in a format that improves the operability of the management of the network system by the user of the management apparatus.

According to a management apparatus of the present invention, an identification operation, check operation and monitoring operation can be performed based on respective tables stored in an identifying table storing unit, check table storing unit and default check table storing unit, and monitoring table storing unit. These tables can easily be added, deleted or modified by a user of the management apparatus, thereby providing more easy management functionality that can be customized.

By using an input flow of an identifying condition, a management apparatus of the present invention allows priorities for respective sets in an identifying table to be set when addition and/or deletion is performed with respect to the identifying table, without additional input by a user of the management apparatus. Thus, the management apparatus provides easy management of a network which can be customized.

For example, an identifying table stored in an identifying table storing unit may further include a priority field for storing the priority for a corresponding identifying condition, instead of a format in which the priority is indicated by the position of the row from the top of the table.

A check unit may process, based on priorities like in an identifying table, the rows in a check table stored depending on the type of a communication device in a check table storing unit and/or the default check table stored in a default check table storing unit so as to finish the operation at a time when the check condition in one row has been satisfied without processing the remaining row(s), instead of processing all the rows in the check table stored depending on the type of the communication device and/or the default check table. Similarly, a monitoring unit may process the rows in a monitoring table stored in a monitoring table storing unit based on priorities for the rows so as to finish a monitoring operation at a time when a monitoring condition in one row has been satisfied without processing the remaining row(s), instead of processing all the rows in the monitoring table.

According to the present invention, it is possible to provide a management apparatus and a program for providing a management function that is configured so as to allow a user to easily find the management configuration and that can easily be customized, thereby improving convenience of managing a network system.

Although the present invention has been described by way of exemplary embodiments, it should be understood that those skilled in the art might make many changes and substitutions without departing from the spirit and the scope of the present invention which is defined only by the appended claims.

1. A management apparatus for managing a communication device, comprising:
an identifying table storing unit operable to store an identifying table having an identifying condition for determining a type of said communication device, said identifying condition corresponding to a check method of a function of the communication device that satisfies said identifying condition;
an identifying unit connecting to the communication device and said identifying table storing unit and operable to determine whether or not the communication device satisfies said identifying condition; and
a check unit connecting to an output of said identifying unit and operable to determine the function of the communication device by using said check method that corresponds to said identifying condition if the communication device satisfies said identifying condition.

2. A management apparatus as claimed in claim 1, further comprising a check table storing unit connecting to said check unit and operable to store a check table for each type of communication device, said check table having a check condition for determining the function of the communication device based upon a specified function corresponding to said check condition, said check table for each type of the communication device being specified by said check method stored in said identifying table storing unit, wherein
if the communication device satisfies said identifying condition, and satisfies said check condition of said check table for each type of the communication device specified by said check method that corresponds to said satisfied identifying condition, said check unit determines that said communication device has said specified function corresponding to said check condition of said check table for each type of the communication device.

3. A management apparatus as claimed in claim 1, further comprising:
a default check table storing unit connecting to said check unit and operable to store a default check table having a first check condition for determining the function of the communication device based upon a first specified function corresponding to said check condition; and
a check table storing unit connecting to said check unit and operable to store a check table for each type of communication device, said check table being specified by said check method stored in said identifying table storing unit, said check table having a second check condition for determining the function of the communication device based upon a second specified function corresponding to said second check condition,
wherein said check unit determines:
that, in a case where said communication device satisfies said first check condition of said default check table, said communication device has said first specified function corresponding to said first check condition of said default check table, and
that, in a case where said communication device satisfies said identifying condition stored in said identifying table, and satisfies said second check condition of said check table for each type of the communication device specified by said check method that corresponds to said satisfied identifying condition, the communication device has said second specified function corresponding to said second check condition of said check table for said each type of communication device.

4. A management apparatus as claimed in claim 1, wherein said identifying table storing unit stores a monitoring method for monitoring a status of said communication device satisfying said identifying condition, said monitoring method corresponding to said identifying condition, and
the management apparatus further comprising a monitoring unit operable to monitor said status of said communication device by using said monitoring method corresponding to said identifying condition, in a case where the communication device satisfies said identifying condition.

5. A management apparatus as claimed in claim 1, further comprising a specifying unit operable to make a user of said management apparatus specify an address of the communication device and to make said identifying unit and said check unit determine said type and said function of the specified communication device, respectively.

6. A management apparatus as claimed in claim 1, further comprising:
a communication device displaying controller operable to display the communication device on a display of said management apparatus with an image corresponding to said type determined by said identifying unit; and
a function displaying controller operable to show said function of said communication device determined by said check unit,
in a case where a user of said management apparatus made a predetermined operation with respect to said image.

7. A management apparatus as claimed in claim 1, wherein said identifying table has a plurality of sets including respective combinations of identifying conditions for determining the type of communication device and check methods for determining said function of said communication device based upon satisfying a corresponding identifying condition, and said identifying unit determines which one of said identifying conditions is satisfied by said communication device based on predetermined priorities of each said plurality of sets.

8. A management apparatus as claimed in claim 7, further comprising:
an input unit allowing a user of the management apparatus to input said plurality of sets to be registered in said identifying table;
a registration unit connecting to said input unit and operable to register said plurality of sets, input via said input unit, in said identifying table; and
a priority setting unit connecting to said identifying table storing unit and said registration unit, and operable to set said priorities for each said plurality of sets registered in said identifying table based on said respective identifying conditions of said plurality of sets.

9. A management apparatus as claimed in claim 8, wherein, in a case where a first identifying condition of said identifying conditions is included in a second identifying condition of the identifying conditions, said priority setting unit sets said priorities such that a set corresponding to said first identifying condition has a higher priority than a priority of a set corresponding to said second identifying condition.

10. A management apparatus as claimed in claim 8, wherein said management apparatus manages a plurality of communication devices, and said priority setting unit sets said priorities such that a set corresponding to one of said identifying conditions has a higher priority as a number of said plurality of communication devices satisfying said one identifying condition is smaller.

11. A management apparatus for managing a communication device, comprising:
an identifying table storing unit operable to store an identifying table having an identifying condition for determining a type of the communication device, said identifying condition corresponding to a monitoring method for monitoring a status of the communication device satisfying said identifying condition;
an identifying unit connecting to said identifying table and operable to determine whether or not the communication device satisfies said identifying condition; and
a monitoring unit operable to monitor said status of the communication device by using said monitoring method corresponding to said identifying condition, in a case where the communication device satisfies said identifying condition.

12. A computer-readable medium which stores therein a program for use with a management apparatus for managing a communication device, said program comprising:
an identifying table storing unit operable to store an identifying table having an identifying condition for determining a type of said communication device, said identifying condition corresponding to a check method for determining a function of said communication device that satisfies said identifying condition;
an identifying unit operable to determine whether or not said communication device satisfies said identifying condition; and
a check unit operable to determine said function of said communication device by using said check method corresponding to said identifying condition, in a case where said communication device satisfies said identifying condition.

13. A computer-readable medium which stores therein a program for use with a management apparatus for managing a communication device, said program comprising:
an identifying table storing unit operable to store an identifying table having an identifying condition for determining a type of said communication device, said identifying condition corresponding to a monitoring method for monitoring a status of said communication device satisfying said identifying condition;
an identifying unit operable to determine whether or not said communication device satisfies said identifying condition; and
a monitoring unit operable to monitor said status of said communication device by using said monitoring method corresponding to said identifying condition, in a case where said communication device satisfies said identifying condition.
